(19) United States
(12) Patent Application Publication
(10) Pub. No.: US 2013/0176597 A1
(43) Pub. Date: Jul. 11, 2013

(54) INFORMATION PROCESSING APPARATUS, INFORMATION PROCESSING METHOD, AND STORAGE MEDIUM STORING A PROGRAM THEREOF

(71) Applicant: Nobushige Aoki, Tokyo (JP)

(72) Inventor: Nobushige Aoki, Tokyo (JP)

(73) Assignee: CANON KABUSHIKI KAISHA, Tokyo (JP)

(21) Appl. No.: 13/823,215

(22) PCT Filed: Sep. 16, 2011
(86) PCT No.: PCT/JP2011/071774

§ 371 Date: Mar. 14, 2013

(30) Foreign Application Priority Data
Oct. 15, 2010 (JP) 2010-232783

(51) Int. Cl. G06F 17/21

(52) U.S. Cl. CPC G06F 17/218
USPC 358/1.18; 715/234

(57) ABSTRACT

An information processing apparatus acquires a first structured document to have designated a second structured document to be inserted into a prescribed area within the web page that is based on the first structured document, acquires the second structured document designated in the first structured document, and outputs the second structured document in a manner that is distinguishable from the first structured document.

### TECHNICAL FIELD

The present invention relates to an information processing apparatus for processing a structured document, an information processing method, and a storage medium storing a program thereof.

### BACKGROUND ART

Acquiring various information by accessing web pages on the Internet is now common. These web pages are displayed on a display by software called a browser, based on a structured document written in a structured language such as HTML (HyperText Markup Language) or XHTML (Extensible HyperText Markup Language).

Also, using FRAME elements or IFRAME (Inline FRAME) elements in a web page enables other structured documents to be embedded in the web page and displayed in the browser. Thus, in the case where a structured document is embedded in a web page using a FRAME element or an IFRAME element, another web page can be displayed as a partial area of the web page.

On the other hand, in the case of printing a web page with a printing apparatus, depending on the user, he or she may want to print a partial area of the web page rather than the entire web page. In view of this, Japanese Patent No. 3588337 describes a technique for designating an area to be printed within a web page in accordance with an instruction by the user, and extracting and printing the designated area as an image. This enables the user to, for example, select an area within a web page displayed in the browser using a pointing device or the like, and extract and print the selected area as an image.

In the case of designating an area to be printed within a web page, as with the technique described in the abovementioned Japanese Patent No. 3588337, for example, the user is able to view the web page displayed on the display screen, and check the contents of the web page. Also, as described above, in the case where the structured document contains a FRAME element or an IFRAME element, another web page is displayed in a partial area within the web page. The user is able to check the contents of a web page that has been inserted into a web page, and designate an area to be printed within the web page that has been inserted. However, since the inserted web page is displayed as a partial area within a web page, the user has to check the contents of the web page in a small display area.

### SUMMARY OF INVENTION

An aspect of the present invention is to eliminate the above-mentioned problems with the conventional technology. The present invention provides an information processing apparatus that enables a user to easily check a partial area of a web page, an information processing method, and a storage medium storing a program thereof.

The present invention in its first aspect provides an information processing apparatus comprising: first acquiring means for acquiring a first structured document, the first structured document having designated a second structured document to be inserted into a prescribed area within the web page that is based on the first structured document; second acquiring means for acquiring the second structured document designated in the first structured document acquired by the first acquiring means; and outputting means for outputting the second structured document acquired by the second acquiring means in a manner that is distinguishable from the first structured document acquired by the first acquiring means.

The present invention in its second aspect provides an information processing method comprising: acquiring a first structured document, the first structured document having designated a second structured document to be inserted into a prescribed area within the web page that is based on the first structured document; acquiring the second structured document designated in the acquired first structured document; and outputting the acquired second structured document in a manner that is distinguishable from the acquired first structured document.

The present invention in its third aspect provides a computer-readable storage medium storing a program for causing a computer to execute: acquiring a first structured document, the first structured document having designated a second structured document to be inserted into a prescribed area within the web page that is based on the first structured document; acquiring the second structured document designated in the acquired first structured document; and outputting the acquired second structured document in a manner that is distinguishable from the acquired first structured document.

According to the present invention, the user is able to easily check a partial area of a web page.

Further features of the present invention will become apparent from the following description of exemplary embodiments with reference to the attached drawings.

### BRIEF DESCRIPTION OF DRAWINGS

FIG. 1 is a block diagram showing the configuration of a system including an information processing apparatus.

FIG. 2 is a block diagram showing the internal configuration of a PC.

FIG. 3 is a block diagram showing the configuration of software implemented on the PC.

FIG. 4 is a diagram showing an example of a GUI screen displayed on the PC.

FIG. 5 is a diagram showing an example of a GUI screen in the case where a Select Range button is pressed.

FIG. 6 is a diagram showing an example of a GUI screen in the case where an Enlarge Frame button is pressed.

FIGS. 7A and 7B are diagrams showing the GUI screens of area selection child windows.

FIGS. 8A and 8B are flowcharts showing the processing procedure of a structured document print module.

FIG. 9 is a block diagram showing the configuration of software on a PC in Embodiment 2.

FIG. 10 is a block diagram showing the configuration of software on a PC in Embodiment 3.

FIG. 11 is a diagram showing an exemplary data structure of a structured document.

### DESCRIPTION OF EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals are given to constituent elements that are the same, and description thereof will be omitted.

### Embodiment 1

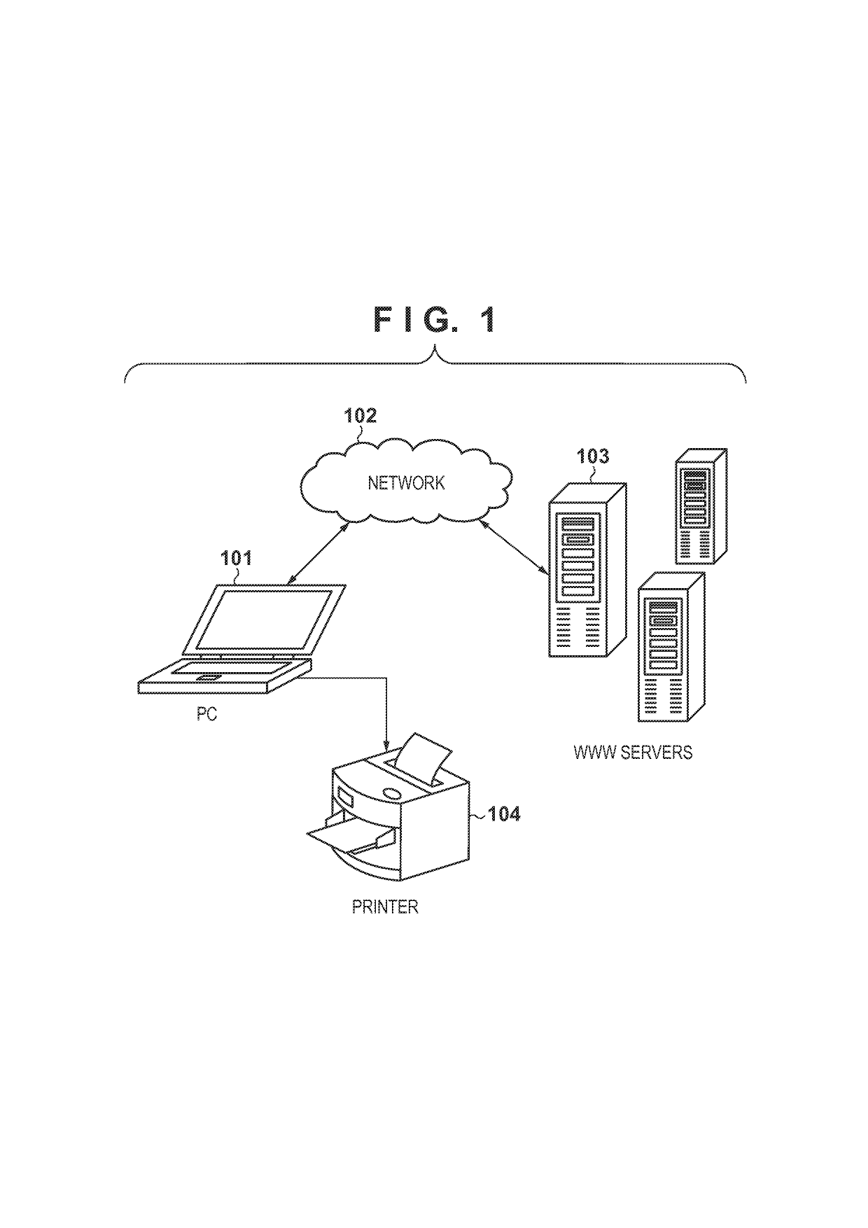

FIG. 1 is a block diagram showing the configuration of a system including an information processing apparatus in an embodiment according to the present invention. A PC 101 serving as the information processing apparatus is able to download structured documents from a plurality of WWW servers 103 to the PC 101 via a network 102 and display web pages. Here, web pages can be displayed based on structured documents written in a structured language such as HTML or XHTML. The PC 101 is also connected to a printer 104, and is able to download web pages on the WWW servers 103 to the PC 101 and print out the web pages on the printer 104.

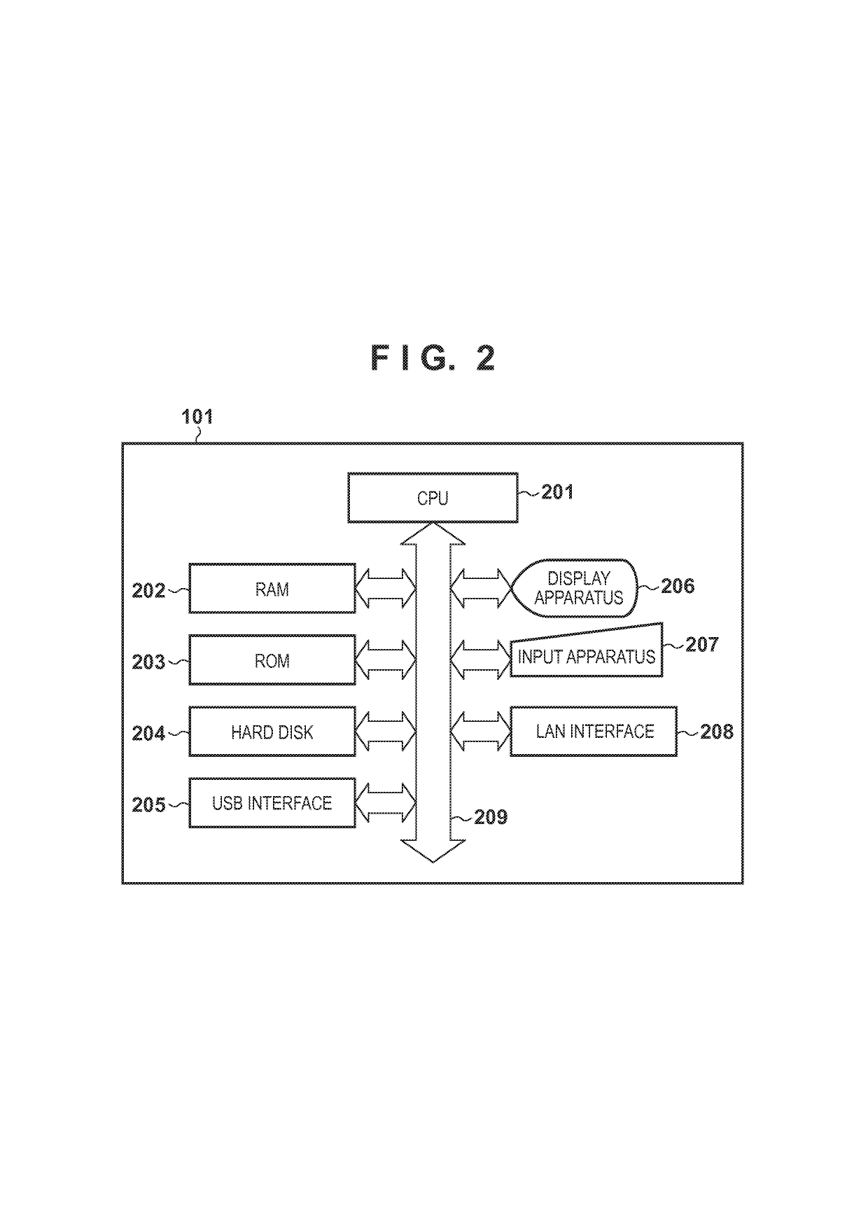

FIG. 2 is a block diagram showing the internal configuration of the PC 101. A CPU 201 processes data and commands in accordance with programs stored on a RAM 202, a ROM 203 or a hard disk 204. The RAM 202 is used as a temporary storage area during various processing by the CPU 201. The hard disk 204 stores an operating system (OS) and a web browser (hereinafter, referred to as a browser), as well as other application software and the like. A USB interface 205 is an interface for having a USB cable connected thereto and performing data communication with the printer 104. Note that communication with the printer 104 may be performed by SCSI, wireless or the like, rather than a USB cable.

A display apparatus 206 includes a CRT or a liquid crystal display and a graphics controller, and displays web pages downloaded from the WWW servers 103, print preview images, GUIs and the like. An input apparatus 207 is for the user to give various instructions to the PC 101, and is, for example, a pointing device or a keyboard. A system bus 209 connects the CPU 201, the RAM 202, the ROM 203, the hard disk 204 and the like, and data to be processed in the PC 101 is communicated over the system bus 209. A LAN interface 208 is an interface for having a LAN cable connected thereto. Data communication by the LAN cable can be performed with the external WWW servers 103 via a router (not shown) and the network 102, using the LAN interface 208. A configuration may also be adopted in which wireless data communication is performed by configuring the PC 101 with a wireless interface. Also, the PC 101 shown in FIG. 2 is a so-called laptop PC 101 in which the display apparatus 206 and the input apparatus 207 are integrated with a control unit that includes the CPU 201, the RAM 202 and the like. However, in the present embodiment, the PC 101 may be a so-called desktop apparatus in which the display apparatus 206 and the input apparatus 207 are separate.

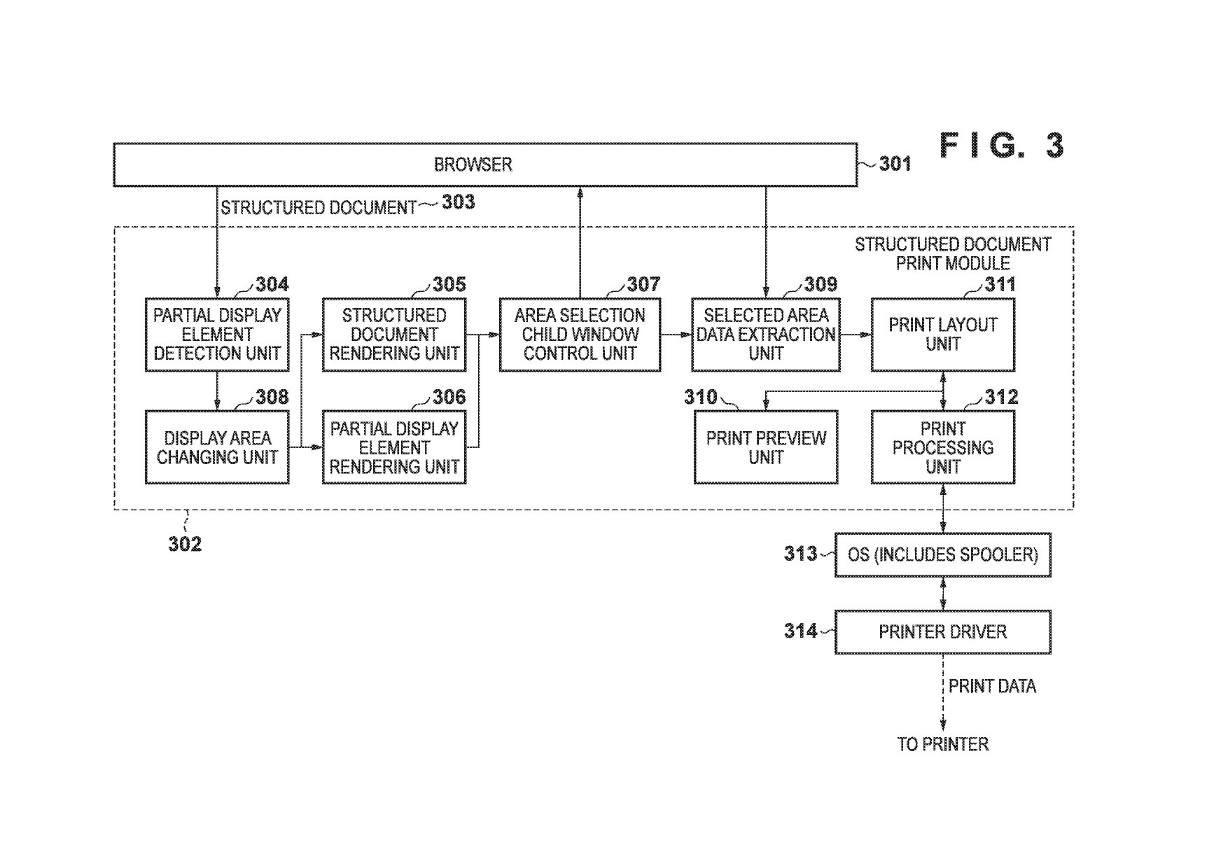

FIG. 3 is a block diagram showing the configuration of software executed by the PC 101, with programs corresponding to the functional blocks shown in FIG. 3 being stored on the ROM 203, the hard disk 204 or the like. A browser 301 is an application for displaying web pages, and functions to download structured documents from the WWW servers 103 to the hard disk 204 of the PC 101, and display web pages on the display apparatus 206. A structured document such as the above is written using HTML, XHTML or the like, and elements such as text and images constituting the structured document are described using tags. A separate file called a CSS (Cascading Style Sheet) designating the display style of these elements is designated in the structured document. The browser 301 analyzes a structured document downloaded to the hard disk 204 and displays a web page on the display apparatus 206.

A structured document print module 302 is plug-in software that is called by the browser 301 with a structured document 303 as a parameter, and acquires the structured document 303 when called by the browser 301. This module acquires a first structured document or a second structured document that are described below. The structured document print module 302 is executed in the case where the user gives an instruction for performing area selection to the browser 301. Here, area selection refers to processing for selecting an area in a web page to be printed, for example. Note that while the following description relates to processing for printing an image of an area selected in the web page, the present invention is not limited thereto, and can be applied in the case where various processing such as display, storage or transfer of an image of a selected area is performed.

A partial display element detection unit 304 detects partial display elements such as IFRAME elements by analyzing the structured document 303 and determining whether any partial display elements are contained therein. Note that a partial display element is an element whose display is partially restricted when a web page is displayed based on the structured document 303. Elements for inserting a structured document, such as IFRAME elements, for example, may be detected, or elements for which scroll display is designated by an overflow attribute may be detected. A partial display element rendering unit 306 displays images based only on partial display elements detected by the partial display element detection unit 304, among the elements contained in the structured document 303.

A display area changing unit 308 switches the display in a structured document display area in which a web page is displayed in the browser 301, in the case where it is determined by the partial display element detection unit 304 that the structured document 303 contains a partial display element. In the present embodiment, the display area changing unit 308 switches display in the structured document display area of the browser 301 between display of the entire web page based on the entire structured document using a structured document rendering unit 305, and display based only on the partial display element detected by the partial display element rendering unit 306. In other words, when the entire web page is displayed, an element that is partially displayed in the web page can be enlarged. This switching of the display is performed in response to an instruction being input by the user, for example.

Note that at this time the structured document rendering unit 305 performs rendering in a storage area (not shown) of the RAM 202 based on the entire structured document, and creates an intermediate data file. The partial display element rendering unit 306 renders the entire partial display element including hidden areas of the element in the structured document that are not displayed in the web page, based on the storage area (not shown), and creates an intermediate data file. At this time, since the entire partial display element is rendered, areas that are not displayed (hidden areas) when the web page is displayed based on the structured document 303 are also rendered. Also, whether an intermediate data file is created in the structured document rendering unit 305 or the partial display element rendering unit 306 is dependent on the switching by the display area changing unit 308.

Note that an intermediate data file is a file that holds character information and graphics information as vector data rather than bitmap data, and is created in order to display or print a web page, for example. In particular, with the present embodiment, in order to enable a given area within a web page to be selected and extracted, that is, in order to enable part of an element in a structured document to be extracted, the intermediate data file desirably is capable of extracting part of the vector data. A PDF (Portable Document Format) file, an EMF (Enhanced Metafile Format) file, an XPS (XML Paper Specification) file or the like, for example, can be used as such an intermediate data file.

An area selection child window control unit 307 performs rendering based on an intermediate data file created by the structured document rendering unit 305, and displays a web page in the browser 301. At this time the area selection child window control unit 307 displays a web page that is based on the entire structured document in the structured document display area of the browser 301, and enables an arbitrary area of the web page to be selected by the user. Also, the area selection child window control unit 307 displays an intermediate data file created by the partial display element rendering unit 306 as a partial display element in the structured document display area of the browser 301, and enables an arbitrary area thereof to be selected by the user. Note that whether the area selection child window control unit 307 performs display on the browser 301 based on the entire structured document or a partial display element is dependent on the switching by the display area changing unit 308.

A selected area data extraction unit 309 is executed in the case where the user has selected an area within a web page and given a print or print preview start instruction targeting the selected area to the browser 301. The selected area data extraction unit 309 acquires the coordinates and size, in the web page, of an area selection rectangle 502 set by the area selection child window control unit 307, and extracts the element included in this area selection rectangle 502 within the structured document as an intermediate data file. Note that the coordinates and size of the area selection rectangle 502 acquired by the selected area data extraction unit 309 are the absolute coordinates and absolute size in the entire web page. Alternatively, the coordinates and size within the window displayed by the browser 301 in the area in which the web page is displayed may be acquired. In this case, the coordinates and size, in the web page, of the window displayed by the browser 301 are specified. Then, by converting the coordinates and size of the area selected by the user in the window to the coordinates and size in the entire web page based on the coordinates and size of the window, the coordinates and size of the area selected by the user in the entire web page can be acquired. Also, the selected area data extraction unit 309 extracts the element based on the coordinates and size of the area selection rectangle 502 in the entire web page, when the entire structured document is displayed by the area selection child window control unit 307. Incidentally, it may be the case that a partial area of a web page is displayed by the area selection child window control unit 307 based on a partial display element such as an IFRAME element. At this time, the selected area data extraction unit 309 extracts an element contained in the partial display element, based on the coordinates and size of the area selection rectangle 502 in the partial display element.

A print layout unit 311 determines the layout of the intermediate data file extracted by the selected area data extraction unit 309 to correspond to the paper on which the printer will print in accordance with the print settings. Here, print settings include information such as paper size, resolution, and the printable area of the paper, and are acquired from a printer driver 314 via an OS 313. A print preview unit 310 performs rendering in accordance with the element laid out by the print layout unit 311, and displays the rendered image on the display apparatus 206 as a print preview. A print processing unit 312, on receipt of a print start instruction from the user, executes rendering in accordance with placement information of the element laid out by the print layout unit 311. The OS 313 provides an API (Application Programming Interface) for the structured document print module 302 and the printer driver 314 to perform transmission/reception of print settings data and rendering. Also, the OS 313 includes a spooler system for managing print jobs and various control software such as a port monitor for outputting printer commands to a port, although a detailed description thereof is omitted. The printer driver 314 generates print data in accordance with the rendering executed by the print processing unit 312, converts the print data to a printer command, and transmits the printer command to the printer 104. The printer 104 prints an image on paper based on the printer command received from the printer driver 314.

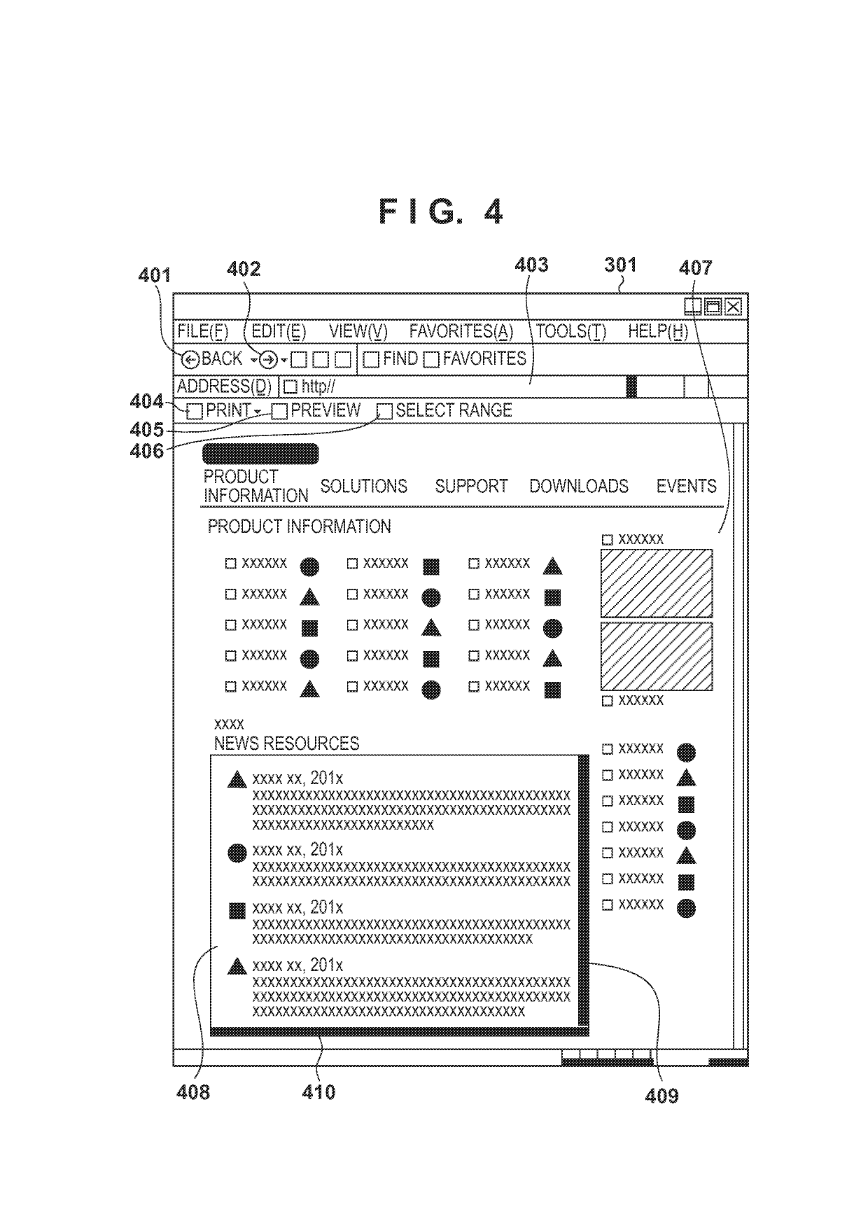

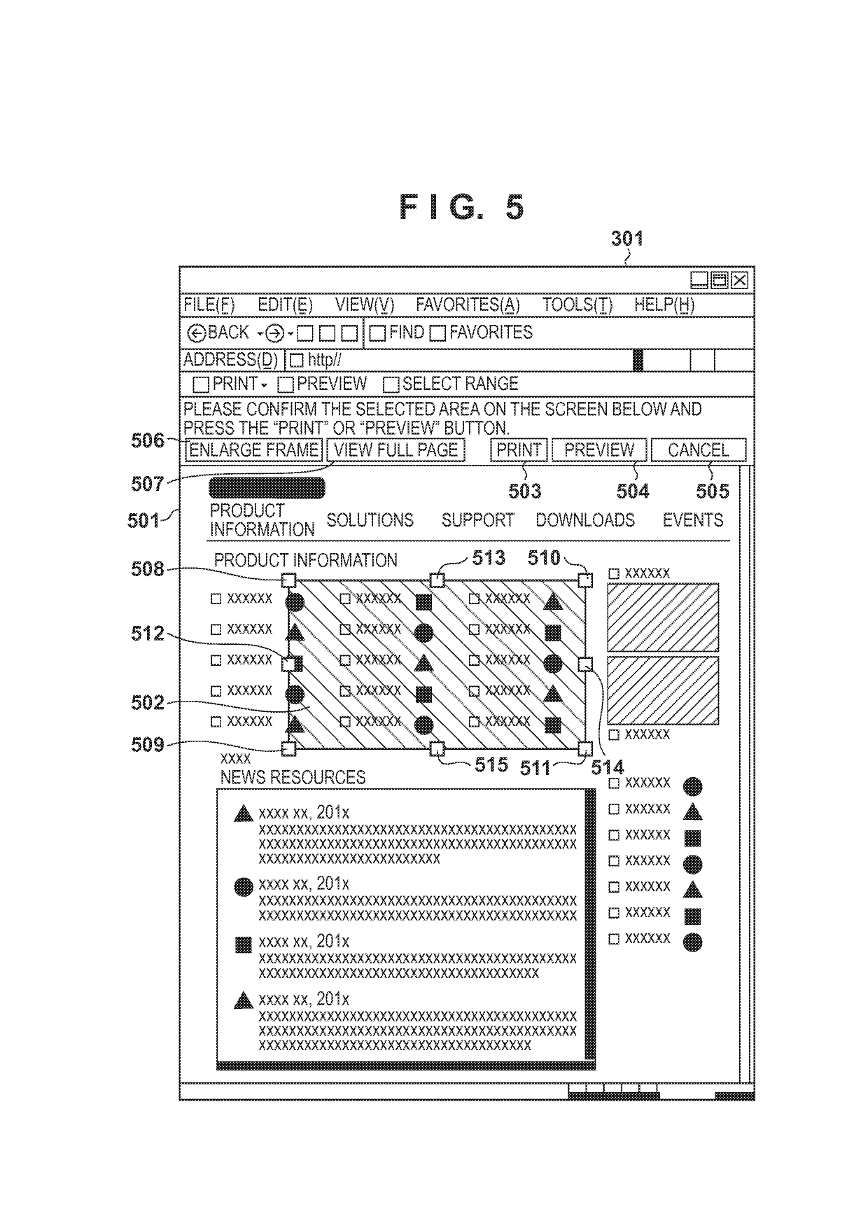

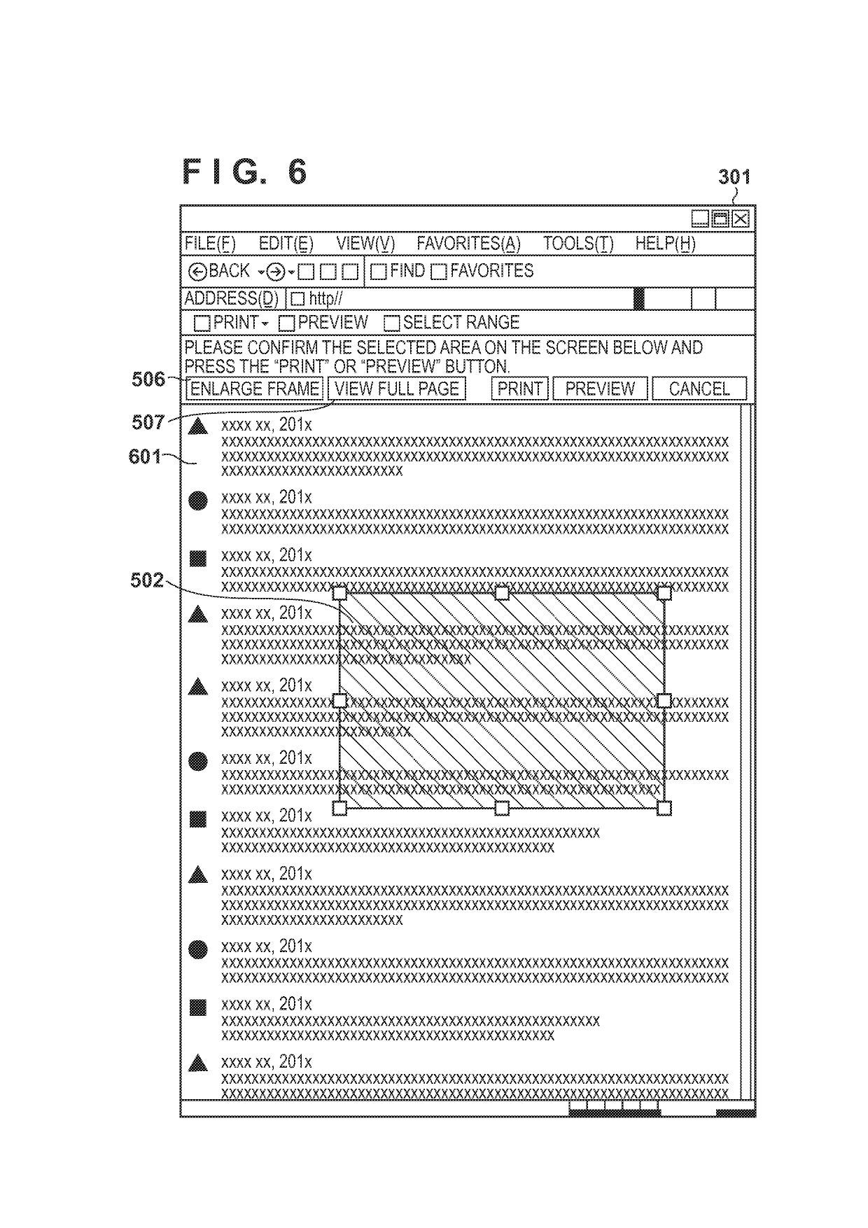

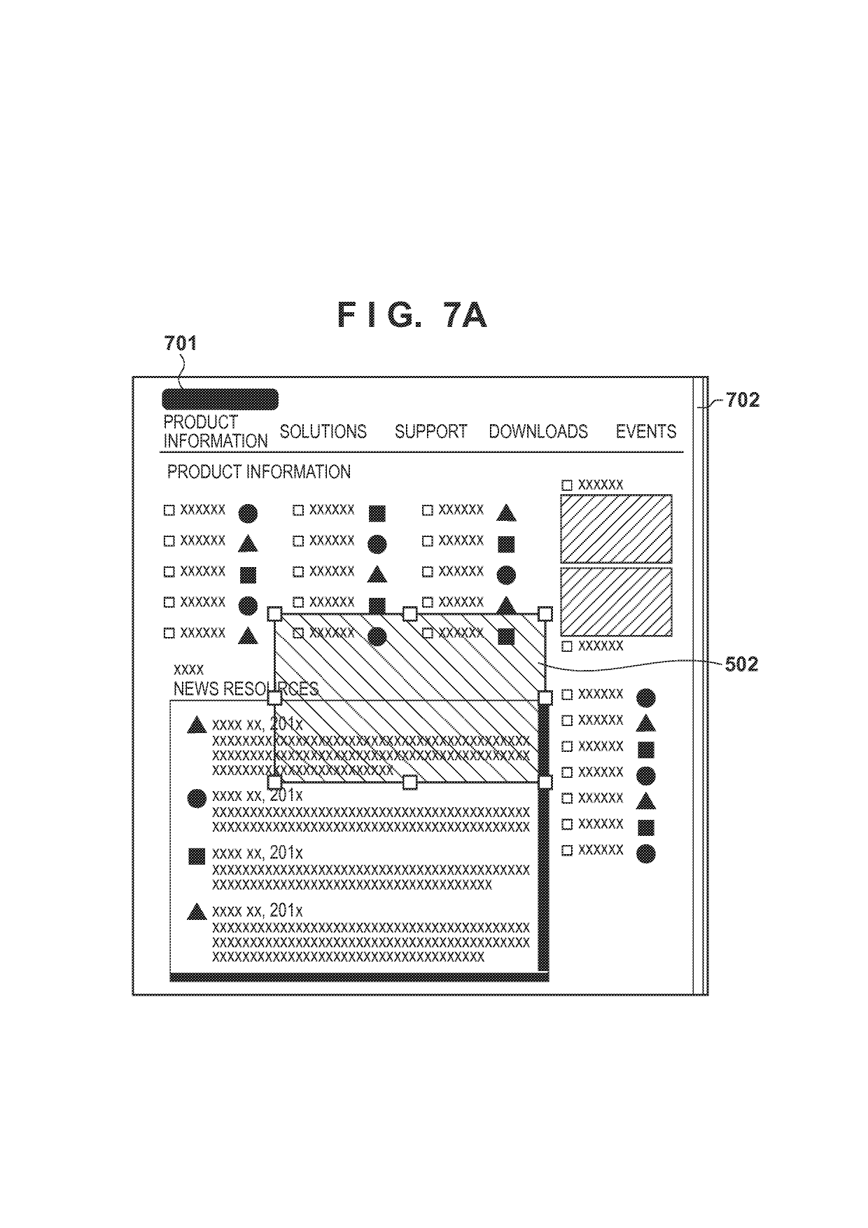

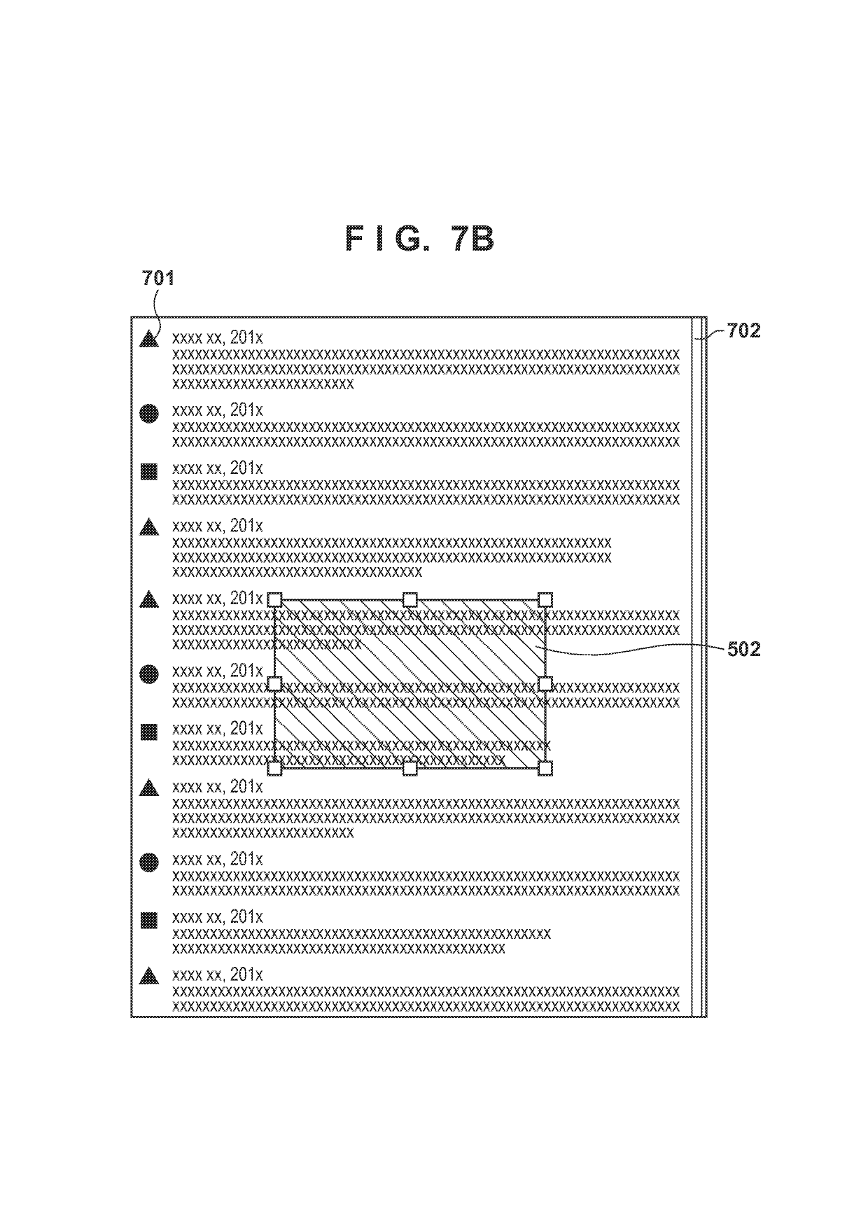

FIG. 4, FIG. 5, FIG. 6, FIG. 7A and FIG. 7B are diagrams showing exemplary GUI screens displayed on the PC 101 in the present embodiment. As shown in FIG. 4, the browser 301 displays a web page on a GUI. The browser 301 is configured with a Back button 401, a Forward button 402 and an address input area 403 for switching the displayed web page. Further, a Print button 404, a Print Preview button 405, and a Select Range button 406 for selecting a range in the web page are configured in the window. When the user presses the Select Range button 406, the browser 301 calls the structured document print module 302.

As shown in FIG. 4, a structured document 408 is an area designated by an IFRAME element and displayed based on a called structured document, and is embedded in a structured document 407. Hereinafter, the structured document 407 will be called a first structured document, and the structured document 408 will be called a second structured document. A vertical scroll bar 409 and a horizontal scroll bar 410 are displayed on the browser 301 for the second structured document 408. The user is able to display the entire contents of the second structured document 408 by operating these scroll bars with an input apparatus 207 such as a pointing device.

FIG. 5 is a diagram showing an example of the GUI screen of the browser 301 in the case where the Select Range button 406 is pressed. The area selection rectangle 502 is displayed by the area selection child window control unit 307. The initial coordinates of the area selection rectangle 502 are set such that the area selection rectangle 502 is placed in the center of the structured document display area in which the web page is displayed in the browser 301. Also, the initial size of the area selection rectangle 502 is determined by a predetermined value. The user can arbitrarily change the coordinates and size of the area selection rectangle 502 by dragging the area selection rectangle 502 with an input apparatus 207 such as a pointing device. Also, the user is able to arbitrarily change the rectangle size by dragging size change marks 508-515 of the four sides and four corners of the area selection rectangle 502 with a pointing device or the like. The area selection child window control unit 307 changes the size and position of the area selection rectangle 502, according to a rectangle size change instruction.

As shown in FIG. 5, a Print button 503 is configured to give a print instruction with the area indicated by the area selection rectangle 502 in the web page targeted for printing. When the Print button 503 is pressed, the selected area data extraction unit 309 acquires the coordinates and size of the area selection rectangle 502 in the web page, and extracts the portion included in the rectangle as an intermediate data file. Note that since an intermediate data file in the present embodiment is capable of extracting part of an element as described above, in the case where the area selection rectangle 502 includes part of an element, the portion of the element included in the rectangle is extracted. Then, after the print layout unit 311 has laid out the extracted intermediate data file, the print processing unit 312 executes print processing.

Also, as shown in FIG. 5, a Preview button 504 is configured for displaying a print preview with the area selection rectangle 502 targeted for printing. When the Preview button 504 is pressed, the selected area data extraction unit 309 acquires the coordinates and size of the area selection rectangle 502 in the web page, and extracts the portion included in the rectangle as an intermediate data file. The print layout unit 311 determines the layout based on the extracted intermediate data file, and the print preview unit 310 renders the intermediate data file extracted by the selected area data extraction unit 309 in accordance with the layout determined by the print layout unit, and displays a print preview screen. A Cancel button 505 is also configured for cancelling area selection, and display returns to the state of FIG. 4 in the case where the Cancel button 505 is pressed.

Also, as shown in FIG. 5, an Enlarge Frame button 506 is configured for enlarging display of a partial display element of the web page. The Enlarge Frame button 506 is displayed in an enabled state in the case where the web page contains a partial display element, and when the button 506 is pressed by the user, the second structured document 408 is displayed in the entire structured document display area of the browser 301, for example.

FIG. 6 is a diagram showing an example of a GUI screen of the browser 301 in the case where the Enlarge Frame button 506 is pressed. As shown in FIG. 6, the second structured document 408 is displayed in the entire structured document display area of the browser 301. The user is also able to select part of an IFRAME element 601 using the area selection rectangle 502 when the screen shown in FIG. 6 is displayed. That is, in the present embodiment, the user can display the IFRAME element 601 in a larger area, and select an area in an image that is based on the IFRAME element using most of the area of the browser screen. Note that a View Full Page button 507 shown in FIG. 6 is for going back to full structured document display, with display returning to the state of FIG. 5 when the button 507 is pressed.

Note that in the present embodiment an example was described in the case where one partial display element such as an IFRAME element is included. However, in the case where a plurality of IFRAME elements are included, the IFRAME element corresponding to the largest area in the web page, among the plurality of IFRAME elements, may be enlarged in the case where the Enlarge Frame button 506 of FIG. 5 is pressed. Also, in the case of there being a plurality of IFRAME elements, a configuration may be adopted in which a screen for the user to select an IFRAME element to be enlarged is displayed. In this case, the IFRAME element selected by the user is displayed in the entire structured document display area as with the IFRAME element 601 shown in FIG. 6. Also, in the present embodiment, an example was described in the case where an IFRAME element is included as a partial display element, but the partial display element may a FRAME element or an element having an overflow attribute attached. Also, in the case where a partial display element is enlarged as shown in FIG. 6, the user is able to select an area to be output by designating the area selection rectangle 502. At this time, the selected area data extraction unit 309 extracts intermediate data, based on the coordinates and size of the area selection rectangle 502 in the partial display element.

FIG. 7A is a diagram showing a GUI screen of the aforementioned area selection child window. In the above description, the GUI screen of the browser 301 is displayed, as shown in FIG. 5, in the case where the Select Range button 406 is pressed in FIG. 4. However, as one example implementation, an area selection child window 701 may be displayed as a child window placed on the window of the browser 301, as shown in FIG. 7A, when the Select Range button 406 is pressed. The area selection child window control unit 307 displays an image rendered by the structured document rendering unit 305 on the display apparatus 206 as such a child window.

The area selection child window control unit 307 renders the structured document 303 acquired from the browser in the area selection child window 701. The area selection child window 701 displays a scroll bar 702, in the case where the web page based on the first structured document 407 is larger than the child window. The user is able to display all areas of the structured document by scrolling the scroll bar 702.

The area selection child window 701 further displays the area selection rectangle 502 as a translucent rectangle. The area selection child window control unit 307 performs re-rendering after changing the coordinates and size of the area selection rectangle 502 in the web page that is based on the structured document 303, as the result of an instruction to change the size of the area selection rectangle 502 given by the user using an input apparatus 207 such as a pointing device. The user is able to designate an arbitrary rectangular area of the structured document as a selected area using an input apparatus 207 such as a pointing device. Note that the area selection child window 701 shown in FIG. 7A is displayed using an intermediate data file generated by the structured document rendering unit 305 based on the first structured document 407.

FIG. 7B is a diagram showing an example of a GUI screen in the case where only the second structured document 408 is displayed in the area selection child window 701. FIG. 7B is displayed in the case where the Enlarge Frame button 506 is pressed on the screen of FIG. 5. FIG. 7B is similarly a child window that is displayed instead of FIG. 6 as one exemplary implementation. An image is rendered in the area selection child window 701 of FIG. 7B by the partial display element rendering unit 306, based only on the second structured document 408 included in the first structured document acquired from the browser. Also, the area selection child window 701 displays the scroll bar 702, in the case where the web page based on the second structured document 408 is larger than the child window. The user is able to display all areas of the second structured document 408 by scrolling the scroll bar 702. Note that the area selection child window 701 shown in FIG. 7B is displayed using an intermediate data file generated by the partial display element rendering unit 306 based on the second structured document 408.

Here, the data structure of a structured document used in the present embodiment will be described.

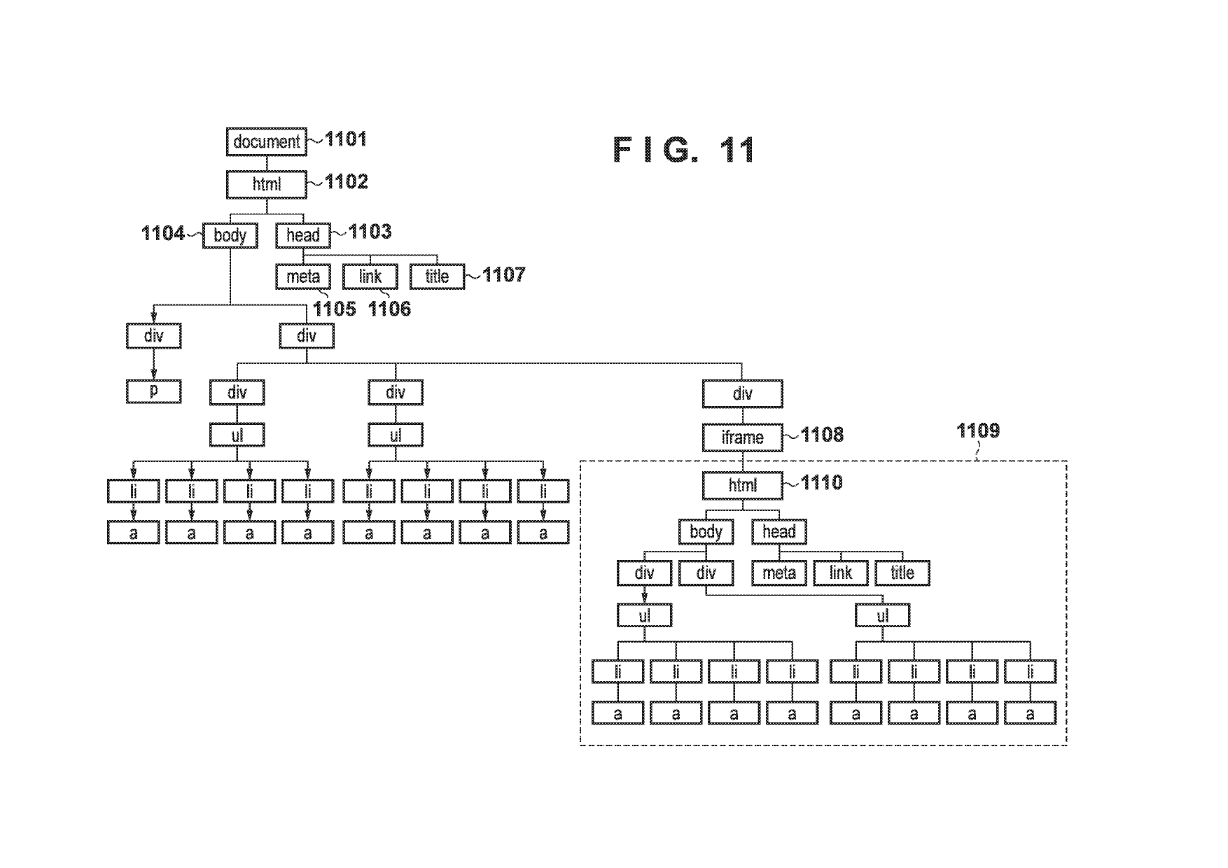

FIG. 11 is a diagram showing an exemplary data structure of a structured document. The elements of a structured document used in the present embodiment have a hierarchical structure (DOM (Document Object Model) tree). The DOM tree has a <document> node 1101 representing the entire document as a root node, and an <html> node 1102 as a child node of the root node. The <html> node 1102 further has a <body> node 1104 and a <head> node 1103 as child nodes.

Each element node holds data such as a pointer to a parent element node, a pointer to a sibling node, a pointer to a list of child nodes, attribute information, and text information. The display state and layout information of each element is defined in a CSS file, and the CSS files are stored in a temporary storage area as information on the element nodes of the DOM tree. For example, the font type, font size, character color and display position of the element are stored as such information on the element nodes. In the present embodiment, only elements are treated as nodes, and attribute and text information are treated as information on the element nodes. However, attribute and text information may also be treated as nodes of the DOM tree.

As shown in FIG. 11, the DOM tree contains an IFRAME element 1108. Typically, an IFRAME element within a first structured document only designates a second structured document to be inserted into a web page using an src attribute, and the element of the second structured document to be inserted is not actually included in the first structured document. Thus the element nodes of the second structured document designated by the src attribute of the IFRAME element constitute a separate DOM tree 1109, rather than being included in the DOM tree of the first structured document. In FIG. 11, the DOM tree of the first structured document and the DOM tree of the second structured document are shown as a single DOM tree.

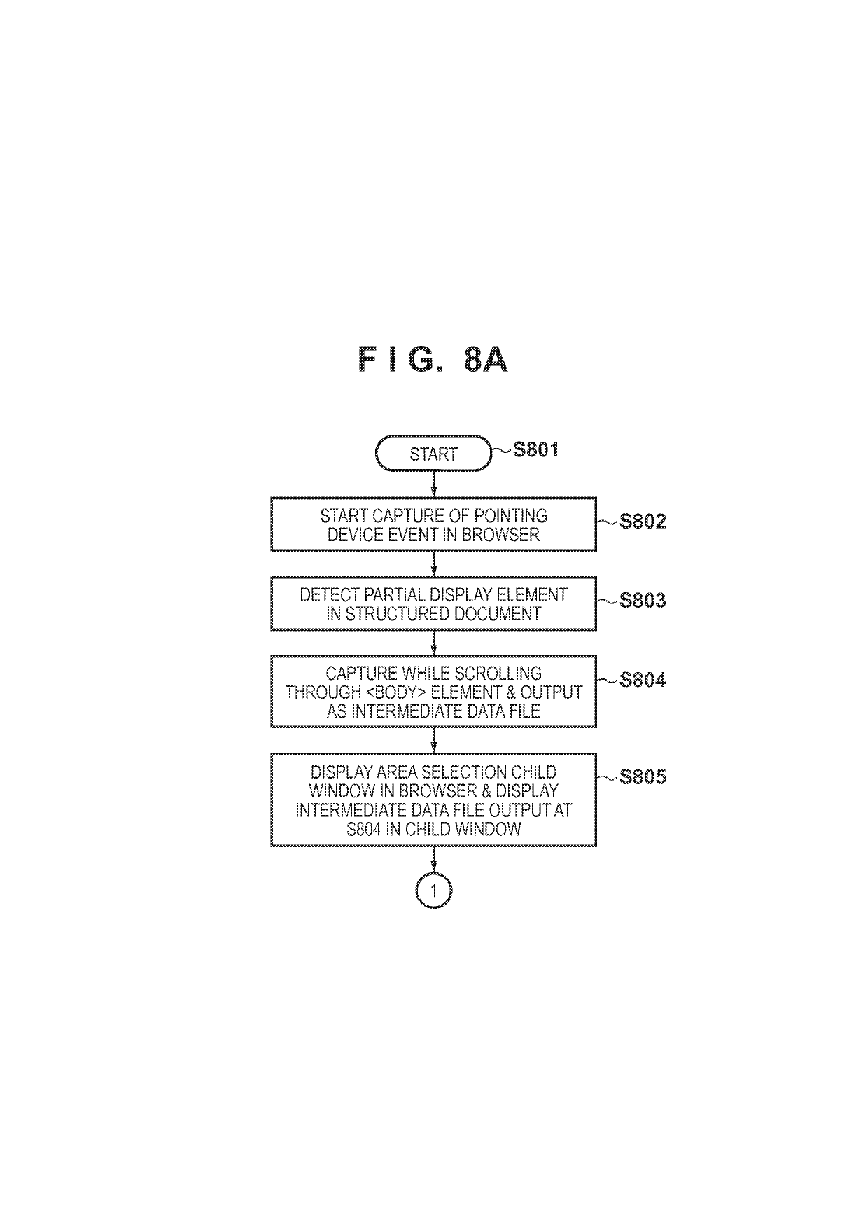

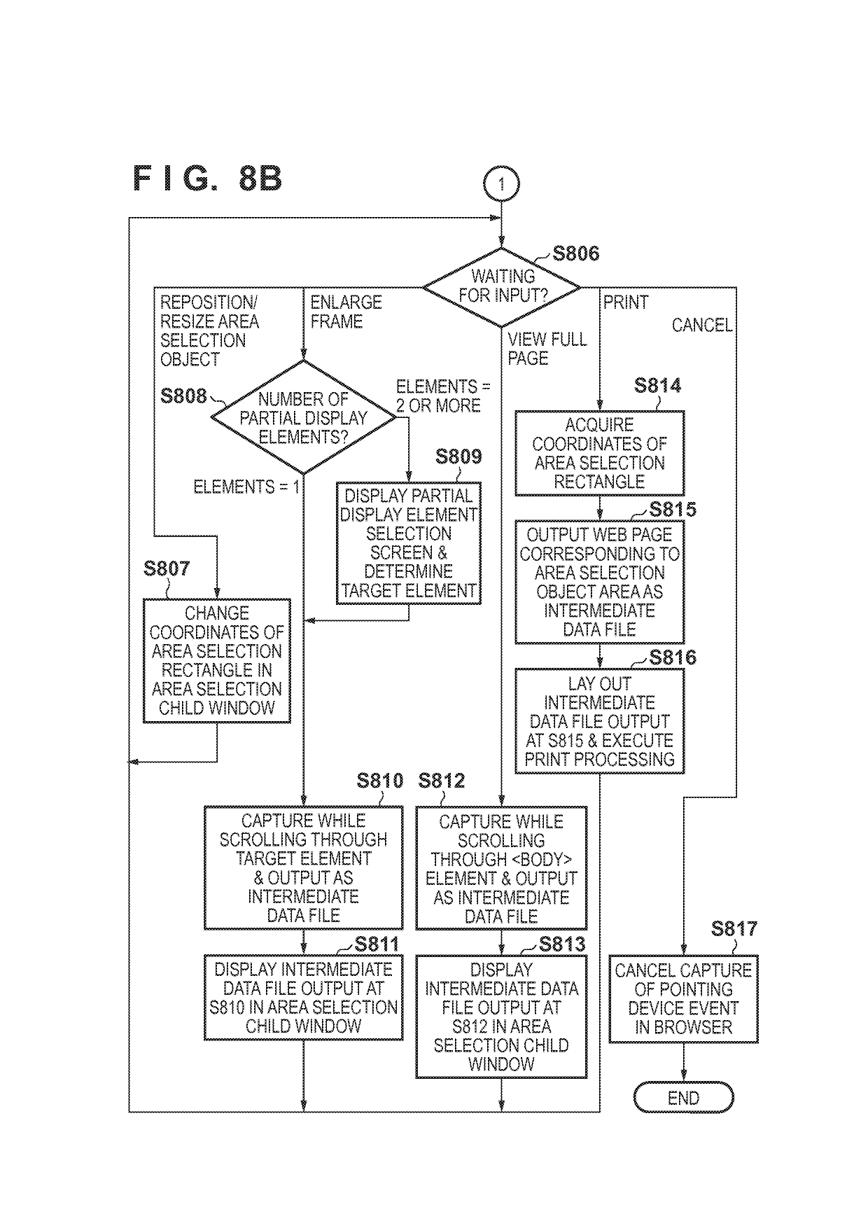

FIGS. 8A and 8B are flowcharts showing the display control processing procedure by the structured document print module 302. The processing shown in FIGS. 8A and 8B can be realized by the CPU 201 executing programs corresponding to the functional blocks of software shown in FIG. 3. In S801, first, the structured document print module 302 is launched when the Select Range button 406 in the browser 301 is pressed by the user in the state of FIG. 4. In S802, processing to capture an event of the pointing device in the structured document display area of the browser 301 is started. Note that the processing to capture an event of the pointing device is performed entirely by the area selection child window control unit 307.

In S803, partial display elements within the structured document are detected by the partial display element detecting unit 304. Here, when a partial display element is detected, the Enlarge Frame button 506 is displayed in an enabled state in the browser 301 by the display area changing unit 308. Note that, in the present embodiment, the number of detected partial display elements is stored in the storage area of the RAM 202 or the like. Note also that the View Full Page button 507 is displayed in the browser 301 in a disabled state.

In S804, the structured document display area is rendered by the structured document rendering unit 305 to create an intermediate data file in EMF format. At this time, in the present embodiment, an EMF intermediate data file for the entire structured document is created by repeating the rendering process for different display areas while scrolling through the <body> element.

In S805, the intermediate data file for the entire structured document created at S804 is displayed in the area selection child window 701, as shown in FIG. 7A, by the area selection child window control unit 307. The translucent area selection rectangle 502 is also displayed therewith in the area selection child window 701.

In S806, the processing waits for input of a pointing device operation by the user. Here, in the case where the Cancel button 505 is pressed, the processing proceeds to S817, where the process of capturing an event of the pointing device is cancelled, and the processing shown in FIGS. 8A and 8B ends. Also, in the case where an operation instructing repositioning and resizing of the area selection rectangle 502 is performed in S806, the processing proceeds to S807. In S807, the coordinates of the area selection rectangle 502 are changed according to the repositioning and resizing operation by the pointing device, and the processing returns to S806.

In S806, in the case where the Enlarge Frame button 506 is pressed, the processing proceeds to S808, where the number of detected partial display elements is determined. Here, in the case where it is determined that two or more partial display elements were detected, a screen for prompting the user to select a partial display element to be enlarged is displayed in S809. Thereafter, the processing proceeds to S810 once the user has selected an element to be enlarged to a larger area. On the other hand, the processing also proceeds to S810 in the case where it is determined that one partial display element was detected, with that partial display element targeted for enlargement. In S810, the display area of the selected partial display element is rendered by the partial display element rendering unit 306 to create an intermediate data file in EMF format. At this time, in the present embodiment, an EMF intermediate data file for the target partial display element is created by repeating the rendering process for different areas in the partial display element that are to be displayed, while scrolling through the partial display element in the state shown in FIG. 4. In S811, the intermediate data file created at S810 is displayed by the area selection child window control unit 307 in the area selection child window 701, as shown in FIG. 7B. The translucent area selection rectangle 502 is also displayed therewith in the area selection child window 701. Note that, in S811, the View Full Page button 507 is in an enabled state.

In the case where the View Full Page button 507 is pressed in S806, the processing of S812 and S813 is executed, and the entire structured document is displayed in the area selection child window 701. The processing of S812 and S813 is respectively similar to the processing of S804 and S805. It may be the case that the View Full Page button 507 is pressed to again display the full page after a single partial display element has been enlarged in S805 to S811.

In the case where the Print button 503 is pressed in S806, the print processing of S814, S815 and S816 is executed, and the processing returns to S806. In S814, the coordinates of the area selection rectangle 502 displayed in the area selection child window 701 are acquired by the selected area data extraction unit 309. At this time, when the entire web page is displayed based on the first structured document, the coordinates in the entire web page are acquired. In the case where part of the web page that is based on the first structured document has been enlarged based on the second structured document, the coordinates in the web page that is based on the second structured document are acquired. In S815, the element corresponding to the area, in the first structured document or the second structured document, having the coordinates acquired at S814 by the selected area data extraction unit 309 is rendered to create an intermediate data file in EMF format. In S816, the layout of the intermediate data file created at S815 is determined by the print layout unit 311 as the layout of the print area, and the print processing unit 312 executes print processing.

The processing shown in FIGS. 8A and 8B enables the structured document print module 302 to enlarge an arbitrary area within the structured document displayed in the browser 301 or a partial display element of the structured document (second structured document shown in FIG. 11), and to select an arbitrary area thereof as an area to be printed. Accordingly, in the case of selecting a partial area of the web page, the hassle of scrolling and making the selection in a small display area within a web page is eliminated, and user-friendliness can be improved.

In the present embodiment, processing to display only the partial display element of a structured document in the entire structured document display area of the browser, and select an arbitrary area in the displayed element, on a display screen of the browser, is possible. Also, in the present embodiment, an intermediate data file is created by repeatedly scrolling and rendering an element selected as a second structured document on FIG. 4, rather than acquiring an IFRAME element serving as a second structured document and rendering the element in a larger area. Such a method enables the second structured document to be displayed in a child window that is displayed separately, without altering the layout of the second structured document.

Also, in the present embodiment, the case was described where an IFRAME element of a structured document is displayed in the entire structured document display area of the browser. However, an element having an overflow attribute attached or a FRAME element within a structured document can also be similarly displayed in the entire structured document display area of the browser. Also, in the present embodiment, an example implemented with a plug-in for printing a structured document was given, although the present invention is similarly applicable in the case where a structured document is only displayed. Note that in the above description an example was illustrated in which the user selects an area to be printed within a web page, and prints an image by outputting print data to a printer based on the selected area. However, the present invention is not limited thereto, and an image of an area selected by the user within a web page may be displayed on a display apparatus or stored in a storage apparatus.

### Embodiment 2

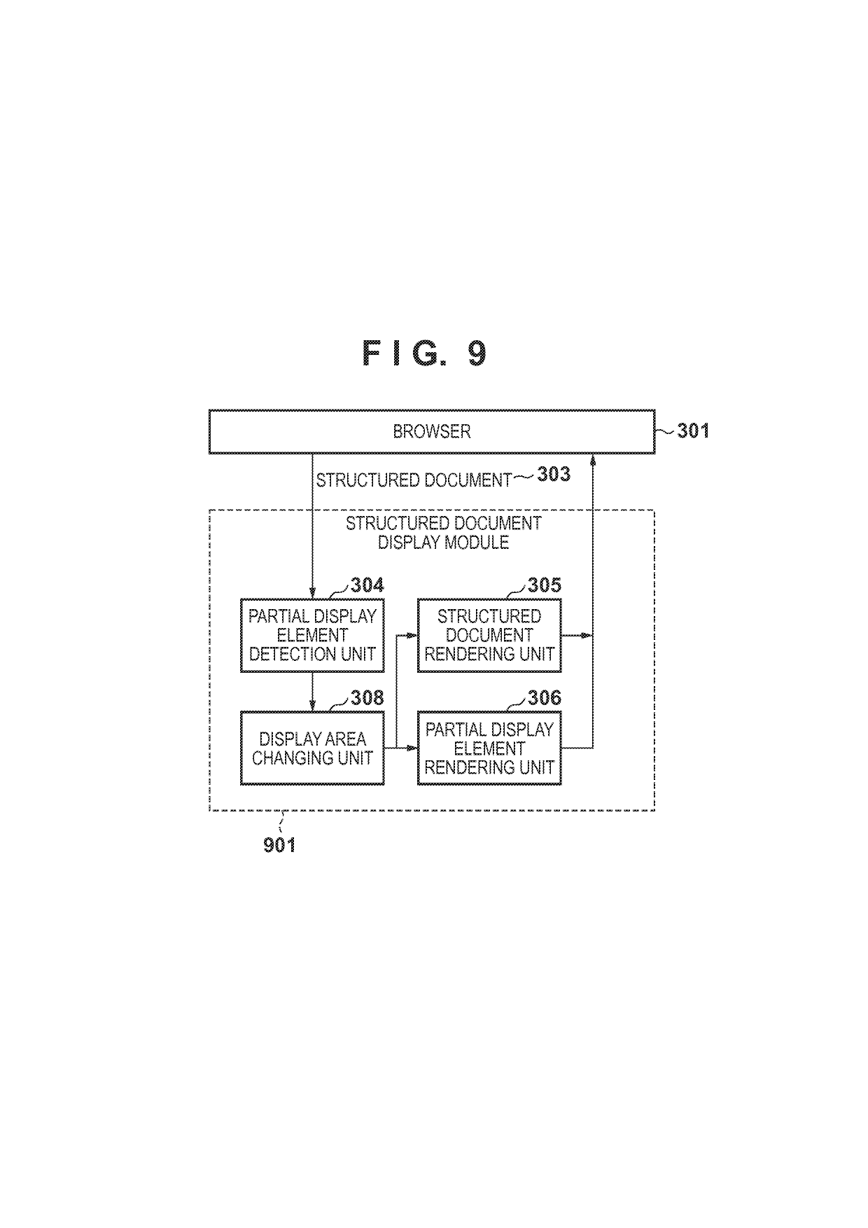

FIG. 9 is a block diagram showing the configuration of software on a PC 101 in the present embodiment. Hereinafter, programs that run on the PC 101 and the data processing configurations thereof will be described. The system configuration in the present embodiment is equivalent to the system in FIG. 1 excluding the printer 104, and the constituent elements are the same as described in FIG. 1. Also, the PC configuration is the same as described in FIG. 2.

A browser 301 is the same as the browser 301 described in Embodiment 1. A structured document display module 901 shown in FIG. 9 is plug-in software called by the browser 301. When the user instructs the browser 301 to display a partial display element, the structured document display module 901 is executed, with a structured document 303 as a parameter. Here, although not illustrated, the instruction to display a partial display element can be realized by configuring a similar button to the Select Range button 406 of FIG. 4 on the browser 301.

With regard to the structured document display module 901, a partial display element detection unit 304, a structured document rendering unit 305, a partial display element rendering unit 306 and a display area changing unit 308 are the same as described in FIG. 3. The structured document display module 901 switches between display of a partial display element of the structured document 303 and display of the entire display structured document, using the partial display element detection unit 304, the structured document rendering unit 305, the partial display element rendering unit 306, and the display area changing unit 308. The user is thereby able to enlarge display of a partial display element contained in a web page.

In the present embodiment, unlike Embodiment 1, the module provided separately to the browser does not necessarily require the function of selecting an area of a structured document and printing the selected area. Also, the present embodiment is not limited to switching between display of a partial display element of a structured document and display of the entire structured document, and display of a partial display element of a structured document and display of the entire structured document may be performed simultaneously in different windows.

### Embodiment 3

In Embodiment 1 and Embodiment 2, the structured document print module 302 and the structured document display module 901 are realized as plug-in modules of the browser 301. The present embodiment is described in the case where a structured document display module is provided in the browser 301.

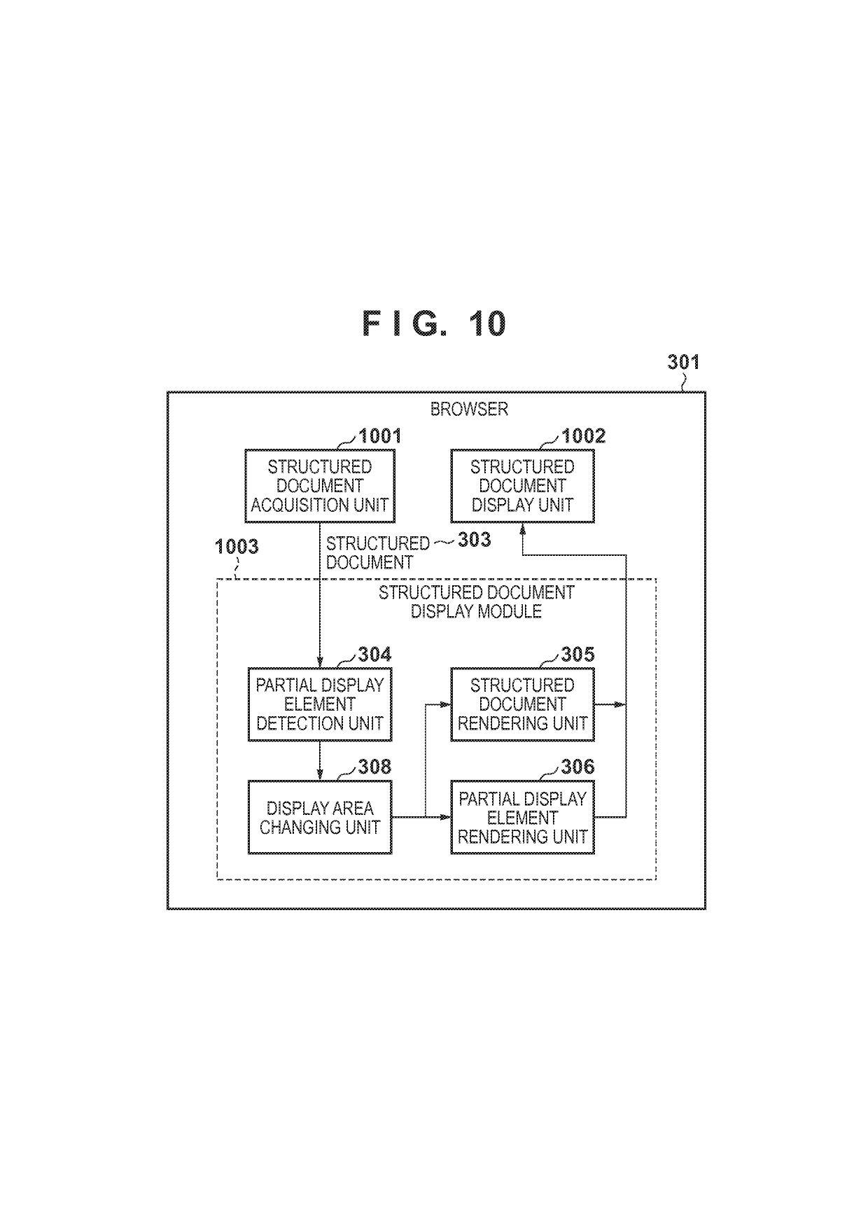

FIG. 10 is a block diagram showing the configuration of software on a PC 101 in the present embodiment. The browser 301 in FIG. 10 differs from Embodiments 1 and 2 in that a structured document display module 1003 is incorporated in the browser.

The browser 301 has a structured document acquisition unit 1001 for acquiring a structured document 303 from a web server and a structured document display unit 1002 that controls display of the structured document. In the case where the user instructs the browser 301 to display a partial display element, the structured document display module 1003 is executed, with the structured document 303 as a parameter. Here, the instruction to display a partial display element is the same as described in FIG. 9.

With regard to the structured document display module 1003, a partial display element detection unit 304, a structured document rendering unit 305, a partial display element rendering unit 306 and a display area changing unit 308 are the same as described in FIGS. 3 and 9. The structured document display module 1003 switches between display of a partial display element of a structured document and display of the entire structured document, using the partial display element detection unit 304, the structured document rendering unit 305, the partial display element rendering unit 306 and the display area changing unit 308.

In the present embodiment, plug-in software is not required, because the browser 301 incorporates the structured document display module 1003. Also, in the above embodiments, processing for detecting a partial display element within a structured document, and displaying the partial display element was performed. However, the present invention is not limited thereto, and processing for outputting a partial display element detected in a web page that is based on a structured document to a storage apparatus to be stored thereon, or processing for transferring a detected partial display element to an external apparatus via a network such as the Internet may be performed, for example. Further, even in the case of printing a partial display element, the present invention is not limited to the case where the user selects an area to be printed as described above, and may be applied in the case where, in response to a partial display element being detected, the entire partial display element or a prescribed area thereof is output to a printer and printed thereon.

Also, in the above embodiments, an example was illustrated in which a link to another structured document is described as an IFRAME element of a structured document, and the linked HTML file is inserted. However, the present invention is not limited thereto, and the user is also able select an element to be output in the case where an HTML file is inserted as a FRAME element, similarly to the case of the above IFRAME element.

Further, in the above embodiments, an example was illustrated in which a structured document is inserted into the frame within a web page. However, the present invention is not limited thereto, and is also applicable in the case where, for example, a link to a document file created by a word processing application or a spreadsheet file created by a spreadsheet application is designated in a structured document, and inserted into a web page. Thus, when extracting a partial area of a document file or a spreadsheet file inserted into a web page, the partial area is extracted as an intermediate data file, similarly to the case where a partial area of a structured document inserted into a web page is extracted. Therefore, even if the partial area is magnified after being extracted, the magnification process is performed on vector data, enabling degradation of the image following magnification to be suppressed in comparison to the case where magnification is performed on bitmap data.

Note that in the above embodiments, HTML and XHTML documents were described as examples of structured documents, although the present invention is also applicable to various types of structured documents such as XML. Further, in the above embodiments, an example was illustrated in which a partial display element contained in a web page is displayed separately to the web page, although the present invention is not limited thereto, and a configuration may be adopted in which a partial display element in a web page is displayed in a manner distinguishable from other elements. In this case, various methods are conceivable, including coloring the area of the partial display element in the web page, for example. Also, in the case where a partial display element within a web page is thus displayed in a manner distinguishable from other elements, the partial display element may be enlarged, in response to an instruction being input by the user.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-232783, filed Oct. 15, 2010, which is hereby incorporated by reference herein in its entirety.

1. An information processing apparatus comprising:
a first acquiring unit configured to acquire a first structured document, the first structured document having designated a second structured document to be inserted into a prescribed area within the web page that is based on the first structured document;
a second acquiring unit configured to acquire the second structured document designated in the first structured document acquired by the first acquiring unit; and
an outputting unit configured to output the second structured document acquired by the second acquiring unit in a manner that is distinguishable from the first structured document acquired by the first acquiring unit.

2. The information processing apparatus according to claim 1, wherein the outputting unit displays a web page that is based on the second structured document acquired by the second acquiring unit on a display apparatus.

3. The information processing apparatus according to claim 2, further comprising:
a specifying unit configured to specify, on the web page that is based on the second structured document displayed on the display apparatus by the outputting unit, a partial area of the web page, according to a user instruction; and
a second outputting unit configured to extract an image of the area specified by the specifying unit from the web page that is based on the second structured document, and outputting the extracted image in a manner that is distinguishable from other areas of the web page.

4. The information processing apparatus according to claim 3,
wherein the second structured document contains an element for placing on a web page, and
the second outputting unit extracts and outputs an image corresponding to a portion of the element placed on the web page, the portion corresponding to the area specified by the specifying unit.

5. The information processing apparatus according to claim 3, wherein the second outputting unit extracts, from intermediate data corresponding to the web page that is based on the second structured document, data corresponding to the area specified on the web page by the specifying unit.

6. The information processing apparatus according to claim 5,
wherein the outputting unit displays the web page that is based on the second structured document on the display apparatus, based on the intermediate data corresponding to the web page, and
the second outputting unit extracts the data from the intermediate data.

7. The information processing apparatus according to claim 1, wherein the outputting unit outputs the second structured document acquired by the second acquiring unit to a printing apparatus, and prints an image that is based on the second structured document on the printing apparatus.

8. The information processing apparatus according to claim 1, wherein the outputting unit outputs the second structured document acquired by the second acquiring unit to a storage apparatus, and stores the second structured document on the storage apparatus.

9. An information processing method comprising:
acquiring a first structured document, the first structured document having designated a second structured document to be inserted into a prescribed area within the web page that is based on the first structured document;
acquiring the second structured document designated in the acquired first structured document; and
outputting the acquired second structured document in a manner that is distinguishable from the acquired first structured document.

10. A computer-readable storage medium storing a program for causing a computer to execute:
acquiring a first structured document, the first structured document having designated a second structured document to be inserted into a prescribed area within the web page that is based on the first structured document;
acquiring the second structured document designated in the acquired first structured document; and
outputting the acquired second structured document in a manner that is distinguishable from the acquired first structured document.
